(19) United States
(12) Patent Application Publication
(10) Pub. No.: US 2010/0015464 A1
(43) Pub. Date: Jan. 21, 2010

(54) HONEYCOMB CORE, AND CONNECTION PIECE AND SANDWICH PANEL FOR THE SAME

(76) Inventor: Kwang Sun Moon, Seongnam-si (KR)

Correspondence Address: CHRISTOPHER PAUL MITCHELL, 888 16TH ST., NW, SUITE 800, WASHINGTON, DC, 20006, US

(21) Appl. No.: 12/528,969

(22) PCT Filed: Feb. 25, 2008
(86) PCT No.: PCT/KR2008/001084

§ 371 Date: Aug. 27, 2009

(30) Foreign Application Priority Data
Feb. 27, 2007 (KR) 10-2007-0019839

(51) Int. Cl. B32B 3/12; B32B 3/26

(52) U.S. Cl. 428/582; 428/116; 428/73; 428/81

(57) ABSTRACT

Disclosed herein area honeycomb core and a sandwich panel for the same. The honeycomb core includes a group of cells, which are continuously arranged in the direction of a two-dimensional plane such that the honeycomb core has the shape of a wide plate having a predetermined thickness. The honeycomb core further includes a plurality of protrusions. The protrusions are protruded from either the upper end or the lower end of the core member of the honeycomb core so as to form an uneven surface structure, and are perpendicular to the thickness direction of the honeycomb core, and partially come into surface contact with a board, which is bonded to the upper or lower surface of the honeycomb core, so as to enable spot welding or laser welding.

### TECHNICAL FIELD

The present invention relates, in general, to a honeycomb core and a sandwich panel for the same and, more particularly, to a honeycomb core, a connection piece for connecting honeycomb cores at a predetermined angle, and a sandwich panel that can increase the bonding strength and can reduce the manufacturing cost thereof using the structural characteristics of the honeycomb core.

### BACKGROUND ART

A sandwich panel is a panel, one type of which enables boards to be respectively attached and fastened to the upper and lower surfaces of a honeycomb core using bonding means, such as an adhesive agent or welding. When forming a wall, such a sandwich panel is widely used as a useful means for maintaining a high ratio of stiffness at a low density in the architectural field, the interior design field, the furniture field and the like.

Examples of methods of manufacturing such a honeycomb core include an expansion method, a corrugation method, a molding method, and an extrusion roll forming method. Furthermore, examples of methods of bonding boards to the upper and lower surfaces of such a honeycomb core include a bonding method using an adhesive agent and a brazing welding method.

The cells of a typical honeycomb core, having a hexagonal section, are formed to have a small size because an upper limit is imposed on the size of cells in order to increase the bonding strength of a sandwich panel. For this reason, it is difficult to bond boards to the core through spot welding. Accordingly, a large amount of cost is required to manufacture the sandwich panel, and satisfactory bonding strength is not achieved. In particular, when a process of bonding boards to a core is performed, boards 102, which are respectively bonded to the upper and lower surfaces of a sandwich panel 100, and a honeycomb core 104, which is mounted in the sandwich panel 100, are bonded perpendicular to each other, as shown in the longitudinal sectional view of FIG. 1. In this case, the bonding area between each board and the honeycomb core 104 is decreased (that is, line contact is achieved), and thus the shear strength, as well as the tension strength, is greatly decreased.

Meanwhile, a description is given with reference to the plan sectional view of FIG. 2. In the sandwich panel 100, in which the honeycomb core is used, a narrow and long frame 106 is mounted to the ends of the boards 102 perpendicular thereto in order to close the side edges (edge portions) of the sandwich panel 100. In this case, with reference to FIG. 1, local portions having low strength always exist in the bonding portions between the upper and lower boards 102 and the frame 106 (the edge portions of the sandwich panel 100) because no bonding means is applied to the contact portions between the honeycomb core 104 and the frame 106.

### DISCLOSURE OF INVENTION

### Technical Problem

Accordingly, the present invention has been made keeping in mind the above problems occurring in the prior art, and an object of the present invention is to provide a honeycomb core, in which the structure thereof is improved, which enables boards to be bonded to the upper and lower surfaces thereof through laser welding or spot welding which can increase the bonding strength of the boards, and which can increase the strength of the edge portions of a sandwich panel, and a sandwich panel for the same.

Furthermore, another object of the present invention is to provide a connection piece, which can connect honeycomb cores at an arbitrary angle, and a sandwich panel using the same.

Furthermore, a further object of the present invention is to provide a three-dimensional sandwich panel, which enables joint portions, which are connected at a pre-determined angle, to be closed, thus not only providing an aesthetic appearance but also making construction convenient.

### Technical Solution

The first object achieved using a honeycomb core, including a group of cells, which are continuously arranged in the direction of a two-dimensional plane such that the honeycomb core has the shape of a wide plate having a predetermined thickness, the honeycomb core further including: a plurality of protrusions protruding from either the upper end or the lower end of the core member of the honeycomb core so as to form an uneven surface structure, and being perpendicular to the thickness direction of the honeycomb core, and partially coming into surface contact with a board, which is bonded to the upper or lower surface of the honeycomb core.

The second object is achieved by bending the side ends of the core member of the honeycomb core to enable surface contact with a frame, which is bonded to the side surface of the honeycomb core.

The third object is achieved using a sandwich panel, in which the protrusions of the honeycomb core and a board is vertically bonded to at least one surface of the above-described honeycomb core through spot welding or laser welding. Furthermore, the third object is achieved by a sandwich panel, in which a frame is bonded to the side surface of the above-described honeycomb core through spot welding.

The third object is achieved using a connection piece, which is used to connect first and second honeycomb cores, having the same construction as the above-described honeycomb core, at an arbitrarily angle, and which is mounted to the connection portions of the first and second honeycomb cores through spot welding or laser welding.

The third object is achieved by connecting a honeycomb core, which includes a group of cells, which are continuously arranged in the direction of a two-dimensional plane such that the honeycomb core has the shape of a wide plate having a predetermined thickness, the honeycomb core further including: a plurality of protrusions protruding from either the upper end or the lower end of the core member of the honeycomb core so as to form an uneven surface structure, and being perpendicular to the thickness direction of the honeycomb core, and partially coming into surface contact with a board, which is bonded to the upper or lower surface of the honeycomb core; wherein each of the protrusions has a short side of 6˜10 mm, thus forming an area for bonding with the board through spot welding or laser welding at a predetermined angle using a connection piece, which includes: an angle forming plate formed by integrating two rectangular plates to each other and configured to have two legs that are spaced apart from each other at the predetermined angle; and first and second connection protrusions configured to respectively protrude from the upper and lower ends of the legs to be perpendicular to the angle forming plate in order to enable the bonding of the boards through spot welding or laser welding and by using a sandwich panel, which is configured such that an inner panel and an outer panel are respectively bonded to the inner and outer surfaces of the honeycomb core, which is connected at a predetermined angle, using welding or an adhesive agent, thus forming two planes having a mutual angle.

### ADVANTAGEOUS EFFECTS

According to the present invention, a honeycomb core, which can greatly increase the stiffness of the sandwich panel itself which is the completed product, can be provided because the wide contact surface with the boards and the frame, which are attached to the upper and lower surfaces and side surface of the honeycomb core, is ensured. Furthermore, an additional effect, in which the number of core members required for each unit area of the sandwich panel can be decreased, is realized thanks to the above-described basic effect. Furthermore, a three-dimensional sandwich panel, which can maintain stiffness at an arbitrary angle, can be provided because the connection piece, which is a means for connecting two honeycomb cores at a predetermined angle, is used.

### BRIEF DESCRIPTION OF THE DRAWINGS

FIG. 1 is a plan sectional view of a portion of a conventional sandwich panel;

FIG. 2 is a side sectional view of the portion of the conventional sandwich panel;

FIGS. 3 and 4 are development views of core members, each of which constitutes a honeycomb core according to an embodiment of the present invention;

FIG. 5 is a perspective view showing a bent core member, according to the present invention;

FIG. 6 is a perspective view showing a completed honeycomb core, according to the present invention;

FIG. 7 is a perspective view showing the coupling between the honeycomb core and a sandwich panel, according to the present invention;

FIG. 8 is a perspective view showing a connection piece for honeycomb cores, according to the present invention;

FIG. 9 is a perspective view showing the use of honeycomb cores, according to the present invention;

FIG. 10 is a partially cut away perspective view of a sandwich panel according to an embodiment of the present invention; and

FIG. 11 is a perspective view of a honeycomb core according to another embodiment of the present invention.

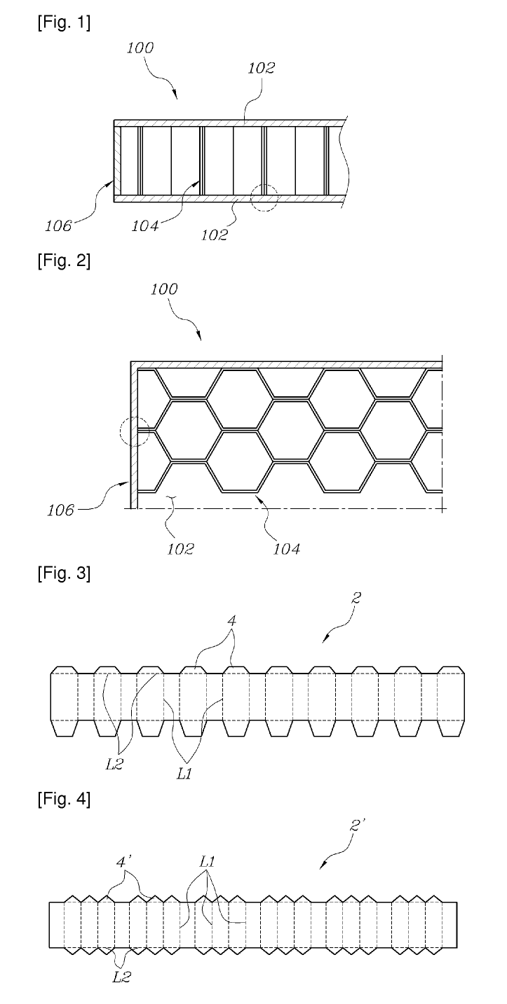

### BEST MODE FOR CARRYING OUT THE INVENTION

Embodiments of the present invention are described in detail with reference to the accompanying drawings below. FIGS. 3 and 4 are respective development views of core members 2 and 2′, each of which constitutes a honeycomb core according to the present invention. Referring to FIGS. 3 and 4, each of the core members 2 and 2′ is a board having a predetermined length in one direction, and the upper or/and lower end of each core member is cut to form an uneven surface structure. The bent portions of each core member are indicated by first bent lines L1, which are dotted lines. Protrusions 4 or 4′, which protrude from the upper or lower reference end of each core member, have a trapezoid shape (refer to FIG. 3) or a triangular shape (refer to FIG. 4), and correspond to portions that are bent along second bent lines L2, which are also dotted lines. The shapes of the protrusions 4 and 4′, shown in FIGS. 3 and 4, are merely examples, and the protrusions 4 or 4′ may be formed to have various shapes, in addition to the shapes shown in the drawings.

The protrusions 4 or 4′ may be formed in both the upper and lower ends the core member 2 or 2′, and may also be formed in any of the ends as needed. One of the core members 2 and 4′ is representatively described in detail below. Each of the protrusions 4 or 4′ has an area set such that spot welding and laser welding are easily performed. For example, it is sufficient if the shape of each of the protrusions 4 or 4′ has a short side of 6˜10 mm, in particular, a short side of 8 mm.

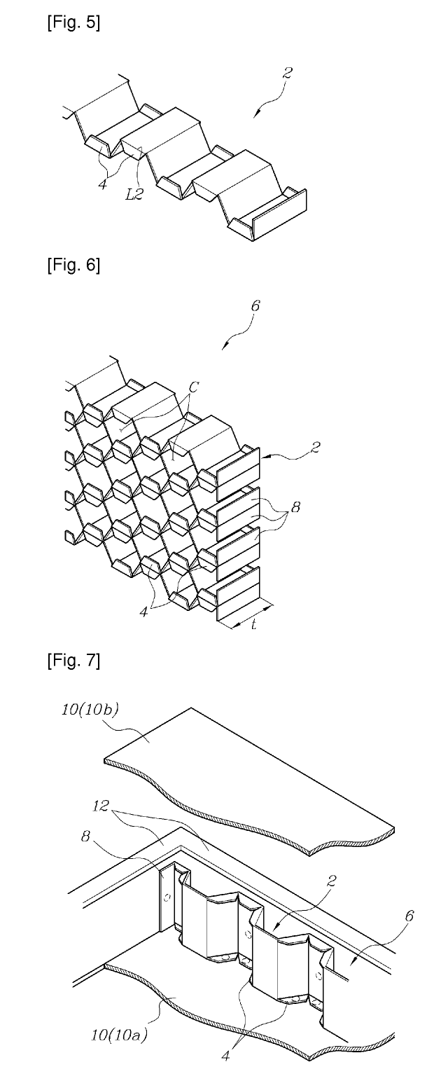

FIG. 5 is a perspective view showing the core member 2, which is bent along the first and second bent lines L1 and L2 in a process of manufacturing a honeycomb core using the core member 2. The structure of FIG. 5 may be formed by simultaneously performing cutting of a plate-shaped raw material and roll forming or may be formed by performing roll forming after cutting a plate-shaped raw material. The protrusions 4 are bent along the second bent lines L2 so as to be perpendicular to the width or thickness direction of the core member 2.

A plurality of unit core members 2, which is bent as shown in FIG. 5, is layered and bonded through welding and thus a completed honeycomb core 6 is manufactured as shown in FIG. 6. In greater detail, the unit core members 2 are bonded to each other through spot welding or laser welding and thus a plate-shaped honeycomb core 6 having a predetermined thickness ‘t’ is manufactured.

Referring to FIG. 6, the honeycomb core 6 of the present invention has a plurality of bonding surfaces, which are formed by the protrusions 4 that are bent perpendicular to the thickness direction of the honeycomb core 6. The area of the bonding surface of one cell may be set so as to occupy about 1/10˜ 1/20 of the sectional area (mm²) of the cell. Here, the range may be adjusted according to the design or the working conditions.

In another embodiment of the present invention, the side ends of the honeycomb core 6 are also bent perpendicular to the area of the honeycomb 6, and thus bent portions 8, which enable surface contact with a frame 12, which will be described later, are provided. The above-described structure brings the honeycomb core 6 into surface contact with boards 10 and the frame 12, which are respectively bonded to the upper and lower surfaces and side surface of the honeycomb core 6.

FIG. 7 is a perspective view showing the coupling among the honeycomb core 6, the boards 10 and the frame 12, according to the present invention. Referring to FIG. 7, the bent portions 8 of the core member 2 are bonded to the inner surface of the frame 12 through spot welding. The upper and lower protrusions 4 of the core member 2 are bonded to the respective inner surfaces of the boards 10 through spot welding. The regions that are indicated by circular dotted lines are welding portions.

The honeycomb core 6 according to the present invention is configured such that the sectional area of each unit cell C (refer to FIG. 6) is wider than that of the conventional honeycomb core. For example, the diagonal length of each unit cell is increased above 50 mm.

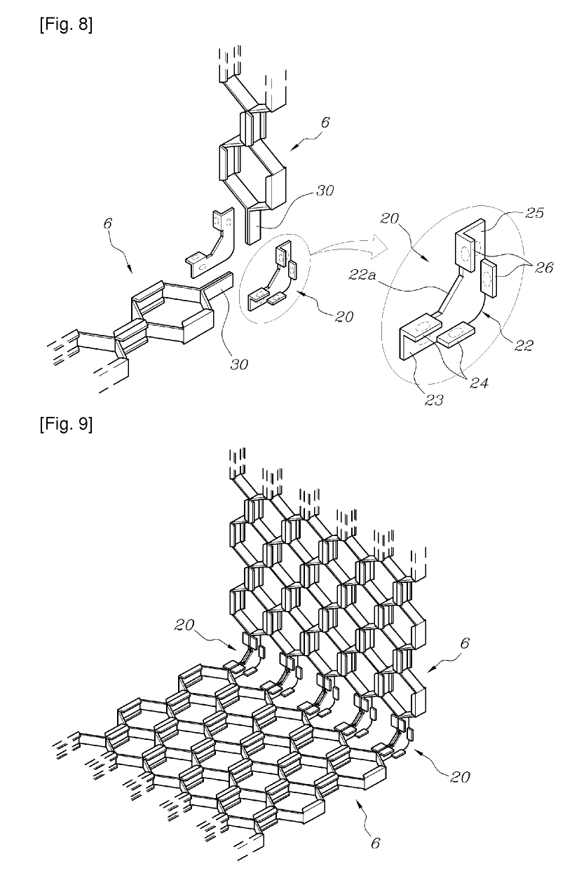

This is intended to enable welding between the honeycomb core and the boards through spot welding but causes a decrease in the weight of a core member 2 that is required for each unit area of the sandwich panel. In order to enable the welding it may be necessary to slightly increase the thickness of the core member and, in addition, to increase the area of each protrusion 4. However, the result, in which disadvantageous factors that may increase costs are satisfactorily removed and, in addition, the costs of material are further reduced, can be obtained by increasing the sectional area of each unit cell C. Meanwhile, a honeycomb core, which includes unit cells each having a particularly wide sectional area, is shown in FIGS. 8 and 9.

In the present invention, in spite of the increase in the sectional area of each unit cell C, the bonding strength of the sandwich panel is not lowered, the shear strength is increased, and the weakness of the edge portions is further mitigated. These are the principal advantages of the present invention.

The welding methods, which are used in the present invention, are described in detail with reference to FIG. 7 below.

First, the bented portions 8 and the outer part of the honeycomb core 6 are welded to the frame 12 as shown in FIG. 7 (which are indicated by circular dotted lines). Subsequently, bonding between the honeycomb core 6 and a lower board 10a is performed using a unidirectional spot welder. Subsequently, welding between the honeycomb core 6 and the upper board 10b is performed in such a way that an upper board 10b is place on the upper surface of the honeycomb core 6 and then a welding gun is brought into contact with the upper board 10b, thus completing a sandwich panel.

In the present invention, spot welding or laser welding has been described as a welding method, but the present invention is not limited merely thereto. Here, a conventional method of selectively using brazing or an adhesive agent as desired by a worker or a designer may be used.

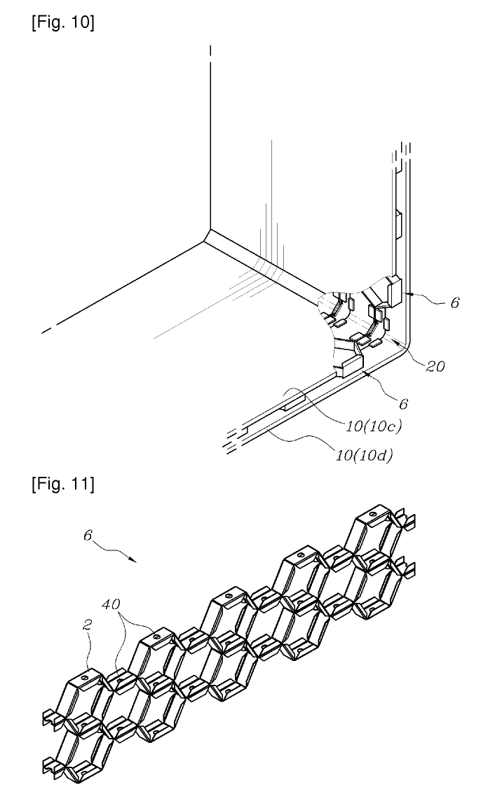

FIG. 8 is a perspective view showing a connection piece for honeycomb cores, according to the present invention, FIG. 9 is a perspective view showing the use of honeycomb cores, according to the present invention, and FIG. 10 is a partially cut away perspective view of a sandwich panel according to an embodiment of the present invention.

The connection piece 20 includes an angle forming plate 22, which is formed by integrating two rectangular plates with each other and is configured to have two legs 23 and 25, which are spaced apart from each other at a predetermined angle (perpendicular to each other, as shown in the drawings), and first and second connection protrusions 24 and 26, which are configured to respectively protrude from the upper and lower ends of the legs 23 and 25 to be perpendicular to the angle forming plate 22. The angle formed by the first connection protrusions 24 and the second connection protrusions 26 is the same as the angle formed by the two honeycomb cores that are desired to be connected to each other.

The connection piece 20 is formed by cutting out a metal board to have a predetermined shape and then bending the first and second connection protrusions 24 and 26. Here, the connection piece 20 is a means for connecting the two honeycomb cores 6 at a desired angle (perpendicular to each other, as shown in the drawings).

In this case, it is preferred that each of the first and second connection protrusions 24 and 26 have an area set such that spot welding or laser welding are possible. In FIG. 8, the portions that will be bonded through spot welding are indicated by circular dotted lines. Reinforcing portions 22a are attached to the joint portions of the legs 23 and 25, which constitute the angle forming plate 22, in order to increase the stiffness thereof.

Furthermore, connection end portions 30 protrude and extend from the respective ends of a honeycomb core 6, which is desired to be connected, so that they can be bonded to the angle forming plate 22 of the connection piece in a surface bonding manner. Here, the bonding may be achieved through spot welding or laser welding. The respective angle forming plates 22 of two connection pieces are bonded to both side surfaces of the connection end portion 30 of each honeycomb core 6, and thus a connection portion is supported by two boards. Consequently, there is no problem with respect to stiffness.

The shape of the connection piece 20 must be determined according to the characteristics (thickness, connection strength, etc.) of a desired sandwich panel, and thus the present invention is not limited to the shape of the connection piece 20 shown in the drawings.

In another embodiment of the present invention, as shown in FIG. 10, two boards 10 are attached to the first and second protrusions 24 and 26 of the connection piece 20 through spot welding or laser welding and thus a sandwich panel having a predetermined angle is provided. That is, two boards 10 are connected to each other at a predetermined angle using the connection piece 20, which was described in conjunction with the previous embodiment, and thus a sandwich panel having two planes is provided. Accordingly, the sandwich panel, having the bent structure shown in FIG. 10, can be provided to customers as an integral unit. Furthermore, the sandwich panel increases the ease of onsite construction and is provided as an integral unit, so that it can provide an aesthetic appearance, attributable to the closing of joint portions. The sandwich panel according to the present embodiment includes an inner panel 10c and an outer panel 10d, which are bent at a predetermined angle or curvature. The inner panel and outer panels 10c and 10d may be implemented by selectively using different materials (for example, copper alloy, aluminum alloy, carbon steel, stainless steel or a zinc-plated plate, synthetic resin, etc.) or colors as needed.

Although not shown, in another embodiment of the present invention, well-known material, which has an insulating sound-proof or combustion-resistant function, may be charged in the vacant spaces of all of the cells of the above-described honeycomb cores in foam form. The above-described material may be arbitrarily selected from among polystyrene, urethane and glass fiber as needed.

As the above-described core member 2, a weldable metallic thin plate is representatively used, but a kind of paper, a kind of synthetic resin and the like may be used. In this case, the boards 10 and the frame 12 must be made of material corresponding thereto, and an appropriate bonding method must be selected.

Material for the boards, which are respectively bonded to the upper and lower surfaces of the honeycomb core 6 of the present invention, is not limited to metal, such as iron, aluminum copper, zinc. That is, nonmetallic material, such as glass, synthetic resin, stone and wood, may be used. In this case, the honeycomb core 6 and the boards 10 may be bonded to each other using an adhesive agent. The above-described sandwich panel may be used in various places and for various purposes. Furthermore, the boards 10 may be made of a combination of two or more different kinds of material.

FIG. 11 is a perspective view of a honeycomb core according to another embodiment of the present invention. Referring to FIG. 9, a plurality of paint holes 40, through which paint can pass, may be formed in the core member 2 of the honeycomb core 6, which is described above. This is to impart a desired color to the honeycomb core 6. That is, liquid paint flows in through the paint holes 40, and thus all of the complicated surfaces of the honeycomb core 6 can be colored. The number of paint holes 40 and the diameter of each paint hole can be determined with reference to ordinary technical knowledge of those skilled in the art based on the usage environment. Here, the paint holes 40 must not cause any problem related to mechanical strength. It should be noted that the paint holes 40 may also be formed in the connection piece 20.

### INDUSTRIAL APPLICABILITY

According to the present invention, a honeycomb core, which can greatly increase the stiffness of the sandwich panel itself which is the completed product, can be provided because the wide contact surface with the boards and the frame, which are attached to the upper and lower surfaces and side surface of the honeycomb core, is ensured. Furthermore, an additional effect, in which the number of core members, which are required for each unit area of the sandwich panel, can be decreased, is realized thanks to the above-described basic effect. Furthermore, a three-dimensional sandwich panel, which can maintain stiffness at an arbitrary angle, can be provided because the connection piece, which is a means for connecting two honeycomb cores at a predetermined angle, is used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A honeycomb core, comprising a group of cells, which are continuously arranged in a direction of a two-dimensional plane such that the honeycomb core has a shape of a wide plate having a predetermined thickness, the honeycomb core further comprising:
a plurality of protrusions protruding from either an upper end or a lower end of a core member of the honeycomb core so as to form an uneven surface structure, and being perpendicular to a thickness direction of the honeycomb core, and partially coming into surface contact with a board, which is bonded to an upper or lower surface of the honeycomb core;
wherein each of the protrusions has a short side of 6˜10 mm, thus forming an area for bonding with the board through spot welding or laser welding.

2. The honeycomb core according to claim 1, wherein the core member comprising bent portions, which are formed by bending two ends of the core member to be perpendicular to the honeycomb core and are configured to come into surface contact with a frame, which is bonded to side surfaces of the honeycomb core.

3. A sandwich panel, which is formed by bonding boards to the upper and lower surfaces of the honeycomb core of claim 1 using welding or an adhesive agent and by bonding a frame to side surfaces of the honeycomb core using welding or an adhesive agent.

4. The sandwich panel according to claim 3, wherein the boards are made of at least one material selected from among metal, glass, stone, and wood.

5. The sandwich panel according to claim 3, wherein the boards and the frame are made of metal, and are bonded to the honeycomb core through spot welding or laser welding.

6. A connection piece, the connection piece being used as means for connecting the honeycomb core of claim 1 at a predetermined angle, the connection piece comprising:
an angle forming plate formed by integrating two rectangular plates to each other and configured to have two legs that are spaced apart from each other at the predetermined angle; and
first and second connection protrusions configured to respectively protrude from upper and lower ends of the legs to be perpendicular to the angle forming plate in order to enable bonding of the boards through spot welding or laser welding.

7. A sandwich panel, which is configured such that the honeycomb core of claim 1 is connected at a predetermined angle using the connection piece of claim 6, an inner panel and an outer panel, which are bent to the predetermined angle, are respectively bonded to inner and outer surfaces of the connected honeycomb core using welding or an adhesive agent, thus forming two planes having a mutual angle.

8. The sandwich panel according to claim 5, wherein the honeycomb core is charged with any of polystyrene, urethane and glass fiber.

9. The honeycomb core according to claim 1, wherein the core member of the honeycomb core comprises a plurality of paint holes, through which liquid paint flows in to impart a desired color to the honeycomb core.
